(19) United States
(12) Patent Application Publication
(10) Pub. No.: US 2010/0043754 A1
(43) Pub. Date: Feb. 25, 2010

(54) CONTROLLER FOR INTERNAL COMBUSTION ENGINE

(75) Inventor: Yasuo Hirata, Chita-gun (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/538,974

(22) Filed: Aug. 11, 2009

(30) Foreign Application Priority Data
Aug. 21, 2008 (JP) 2008-213126

(51) Int. Cl. F02M 59/36; F02D 41/00

(52) U.S. Cl. 123/458; 701/103

(57) ABSTRACT

In a direct fuel injection, a fuel is pressurized by a high-pressure pump and is supplied to a fuel injector. The pressurized fuel is directly injected into a cylinder through a fuel injector. When it is determined that demand fuel discharge amount of the high-pressure pump is greater than a specified value, an energization period of a fuel pressure control valve is prolonged by a specified time period.

### CROSS-REFERENCE TO RELATED APPLICATION

This application is based on Japanese Patent Application No. 2008-213126 filed on Aug. 21, 2008, the disclosure of which is incorporated herein by reference.

### FIELD OF THE INVENTION

The present invention relates to a controller for a direct injection engine in which fuel is pressurized and is injected into the cylinder directly.

### BACKGROUND OF THE INVENTION

Recently, various direct injection engines have been developed. In the direct injection engine, in order to expedite an atomization of the fuel, the fuel is highly pressurized. JP-8-303325A shows a direct injection engine in which the fuel pumped by a low-pressure pump from a fuel tank is pressurized by a high-pressure pump, which is driven by a camshaft of the engine. The pressurized fuel is supplied to a fuel injector.

In such a direct injection engine with the high-pressure pump, by controlling a closing time of a fuel pressure control valve provided in the high-pressure pump, the discharge amount of the high-pressure pump is controlled to adjust the fuel pressure. Specifically in a case of normally open fuel pressure control valve, when the fuel pressure is increased, a closing start timing (energization period) of the fuel pressure control valve is expedited to prolong the closing period of the fuel pressure control valve until the discharge stroke completion so that the discharge amount of the high-pressure pump is increased. On the other hand, when the fuel pressure is decreased, the closing start timing (energization period) is delayed to decrease closing period until the discharge stroke completion so that the discharge amount is decreased.

In JP-8-303325A, in order to reduce the power consumption of the high-pressure pump, after the energization of the fuel pressure control valve is started to close the fuel pressure control valve, when the fuel pressure in the pump chamber is increased to a fuel pressure in which the fuel pressure valve is maintained to be closed, the fuel pressure control valve is deenergized. Even after the deenergization, the fuel pressure in the pump chamber holds the closing state of the fuel pressure control valve, which is referred to as a self-close control.

Generally, an energization control of a fuel pressure control valve of a high-pressure pump is performed based on output signals from crank angle sensor and a cam angle sensor. If detection accuracies of the sensors are deteriorated due to a tolerance dispersion, the discharge amount control of the high-pressure pump can not be performed accurately.

Especially, in the above self-close control, in order to reduce the power consumption, the energization period of the fuel pressure control valve is established as minimal short period. When a demand fuel discharge amount is a maximum discharge amount, the energization period of the fuel pressure control valve is established in such a manner that the fuel pressure in a pump chamber is increased to close the fuel pressure control valve. After deenergization, the closing condition of the fuel pressure control valve until a top dead center of the plunger is maintained by the fuel pressure in the pump chamber.

If the energization period of the fuel pressure control valve is expedited, in a case that the demand fuel discharge amount is the maximum discharge amount, there is a possibility that the energization period of the fuel pressure control valve is finished before a completion of an suction stroke (before bottom dead center of the plunger), or the energization period of the fuel pressure control valve is finished before the fuel pressure in the pump chamber is increased to hold a closing condition of the fuel pressure control valve even after start of discharge stroke (after bottom dead center of the plunger). As the result, after deenergization, the fuel pressure control valve is opened, so that the fuel can not be possibly discharged.

If the energization period of the fuel pressure control valve is delayed due to the tolerance dispersion, in a case that the demand fuel discharge amount is the maximum discharge amount, the closing start timing of the fuel pressure control valve is delayed more than the bottom dead center of the plunger. Correspondingly, the closing period of the fuel pressure control valve until a top dead center of the plunger is shortened. Thus, the maximum discharge amount (maximum closing period of the fuel pressure control valve) is restricted and the maximum discharge performance of the high-pressure pump can not be effectively used.

### SUMMARY OF THE INVENTION

The present invention is made in view of the above matters, and it is an object of the present invention to provide a controller for an internal combustion engine which can improve a controllability around a maximum discharge amount of a high-pressure pump at low cost even in a system where a detection accuracy is deteriorated due to tolerance dispersions of a crank angle sensor and a cam angle sensor

According to the present invention, a controller for an internal combustion engine includes a high-pressure pump and a pump control means. The high-pressure pump includes a pump chamber having a suction port and a discharge port of a fuel, a plunger reciprocating in the pump chamber to suction/discharge the fuel, a valve body opening/closing the suction port, and a fuel pressure control valve closing the valve body by an electromagnetic force. The fuel pressure control valve has a biasing means biasing the valve body in a closing direction. The pump control means controls an energization period of the fuel pressure control valve according to a demand fuel discharge amount for every discharge stroke so that a fuel discharge amount is controlled to the demand fuel discharge amount. The energization period of the fuel pressure control valve is established as a specified period in which the fuel pressure in the pump chamber holds the valve body at a closed position against the biasing force of the biasing means. After the energization is finished, the valve body is hold at the closed position by the fuel pressure until the discharge stroke is finished. The controller further includes a prolong set means for prolonging the energization period of the fuel pressure control valve by a specified period during a period in which the demand fuel discharge amount is greater than a specified amount.

Since the energization period of the fuel pressure control valve is prolonged during a period in which the demand fuel discharge amount is greater than a specified amount, the energization period of the fuel pressure control valve is prolonged by a specified period when the demand fuel discharge amount is around the maximum discharge amount. Even if the energization of the fuel pressure control valve is expedited due to a tolerance variation of the crank angle sensor and a can angle sensor, when the demand fuel discharge amount is around the maximum discharge amount, the energization period of the fuel pressure control valve is prolonged in an advance direction until the fuel pressure in the pump chamber is increased to hold the closing position of the fuel pressure control valve. The controllability of the high-pressure pump around the maximum discharge amount is improved.

Alternatively, even if the energization period of the fuel pressure control valve is delayed due to a tolerance dispersion of sensors, when the demand fuel discharge amount is around the maximum discharge amount, the energization period of the fuel pressure control valve is prolonged in a retard direction in such a manner that a closing start timing of the fuel pressure control valve is brought closer to a bottom dead center of the plunger of the high-pressure pump. According to the present invention, since the conventional problems can be solved by prolonging the energization period of the fuel pressure control valve, a system configuration is not changed and a part of a soft ware is changed to employ the present invention, so that a demand of low cost is satisfied. Furthermore, when the demand fuel discharge amount is less than a specified amount, the energization period of the fuel pressure control valve is not prolonged. An increase in a power consumption is restricted.

### BRIEF DESCRIPTION OF THE DRAWINGS

Other objects, features and advantages of the present invention will become more apparent from the following detailed description made with reference to the accompanying drawings, in which like parts are designated by like reference number and in which:

FIG. 1 is a schematic view of an engine control system according to an embodiment of the present invention;

FIG. 2 is a schematic view of a fuel supply apparatus;

FIG. 3 is a configuration chart showing a high-pressure pump;

FIG. 4 is a time chart showing a behavior of a fuel pressure control valve and a high-pressure pump;

FIG. 5 is a chart conceptually showing a map for computing an energization start timing;

FIG. 6 is a time chart showing a behavior of a fuel pressure control valve and a plunger of a conventional high-pressure pump;

FIG. 7 is a time chart showing a behavior of a fuel pressure control valve and a plunger of a conventional high-pressure pump; and

FIG. 8 is a flowchart showing a processing of a program according to the embodiment.

### DETAILED DESCRIPTION OF EMBODIMENTS

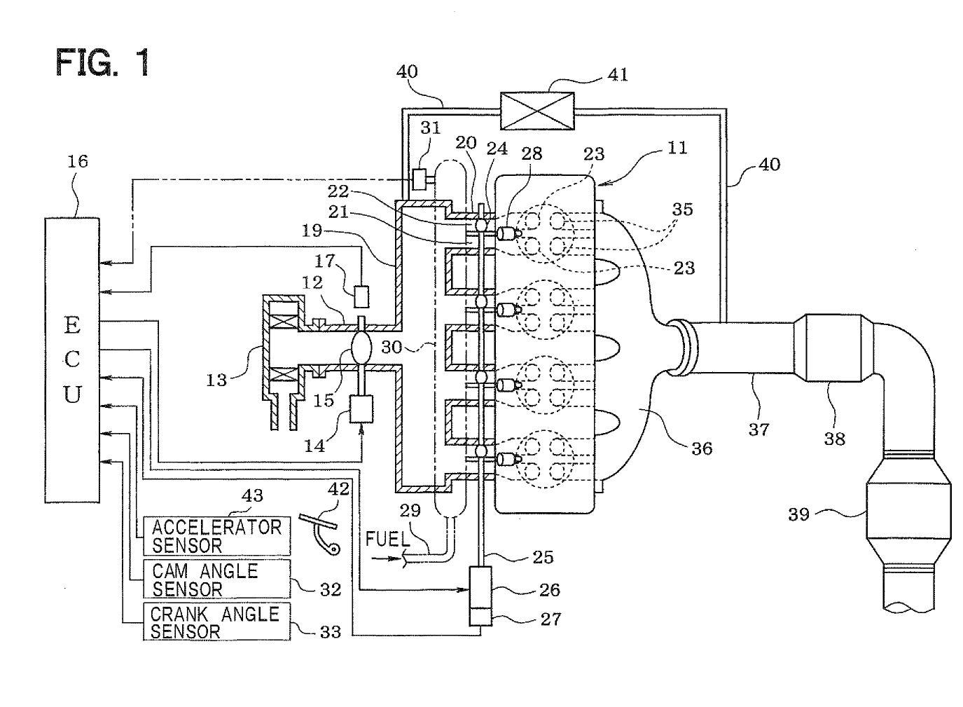

Hereafter, an embodiment of the present invention is described. Referring to FIG. 1, an engine control system is explained. An air cleaner 13 is arranged upstream of an intake pipe 12 of a direct injection engine 11. A throttle valve 15 is arranged downstream of the air cleaner 13. A motor 14 adjusts an opening degree of the throttle valve 15. An opening degree of the throttle valve 15 (throttle opening) is detected by a throttle opening sensor 17.

A surge tank 19 is provided downstream of the throttle valve 15. An intake air manifold 20 is connected to the surge tank 19 to introduce air into the engine 11. Each intake manifold 20 is divided into a first intake passage 21 and a second intake passage 22. The first intake passage 21 and the second intake passage 22 respectively connected to each of two intake ports 23.

An air flow control valve 24 is provided in the second intake passage 22 to control intensities of swirl flow and tumble flow. Each of the air flow control valve 24 is connected to a step motor 26 through a shaft 25. An air flow control valve sensor 27 detecting an opening degree of the air flow control 24 is provided in the step motor 26.

A fuel injector 28 is provided on an upper portion of each cylinder of the engine 11 to inject fuel directly into the cylinder. A high pressure fuel is supplied to each fuel injector 28 by the fuel supply system 50

A spark plug is provided (not shown) on the cylinder head of the engine, the air-fuel mixture in the cylinder is ignited by a spark discharge of the spark plug. A cam angle sensor 32 generates an output pulse when a specified cylinder (for example, a first cylinder). A crank angle sensor 33 generates an output pulse when a crankshaft rotates a specified crank angle (for example, 30°CA) Based on these output pulses, a crank angle and engine speed are detected to discriminate a cylinder.

The exhaust gas discharged from each exhaust port 35 converges in an exhaust pipe 37 through an exhaust manifold 36. In the exhaust pipe 37, a three-way catalyst 38 and NOx catalyst 39 are arrange in series. The three-way catalyst 38 purifies CO, HC, and NOx in the exhaust gas around the stoichiometric air fuel ratio. The NOx catalyst 39 adsorbs NOx in the exhaust gas when the oxygen concentration in the exhaust gas is high. When the air-fuel ratio is switched into the stoichiometric ratio or rich so that the oxygen concentration in the exhaust gas is decreased, the NOx catalyst 39 reduces and purifies the adsorbed NOx, and discharge the NOx.

An EGR pipe 40 connects the upstream of the three-way catalyst 38 and the surge tank 19. A part of the exhaust gas flows in the EGR pipe 40 to be recirculated in the intake side. The EGR pipe 40 is provided with an EGR valve 41 to control an exhaust gas recirculation quantity. An accelerator pedal 42 is provided with an accelerator sensor 43.

The outputs of various sensors are inputted into an electronic control unit (ECU) 16. The ECU 16 includes a microcomputer which executes an engine control program stored in a Read Only Memory (ROM) to control a fuel injection quantity of a fuel injector 28 and an ignition timing of a spark plug according to an engine running condition.

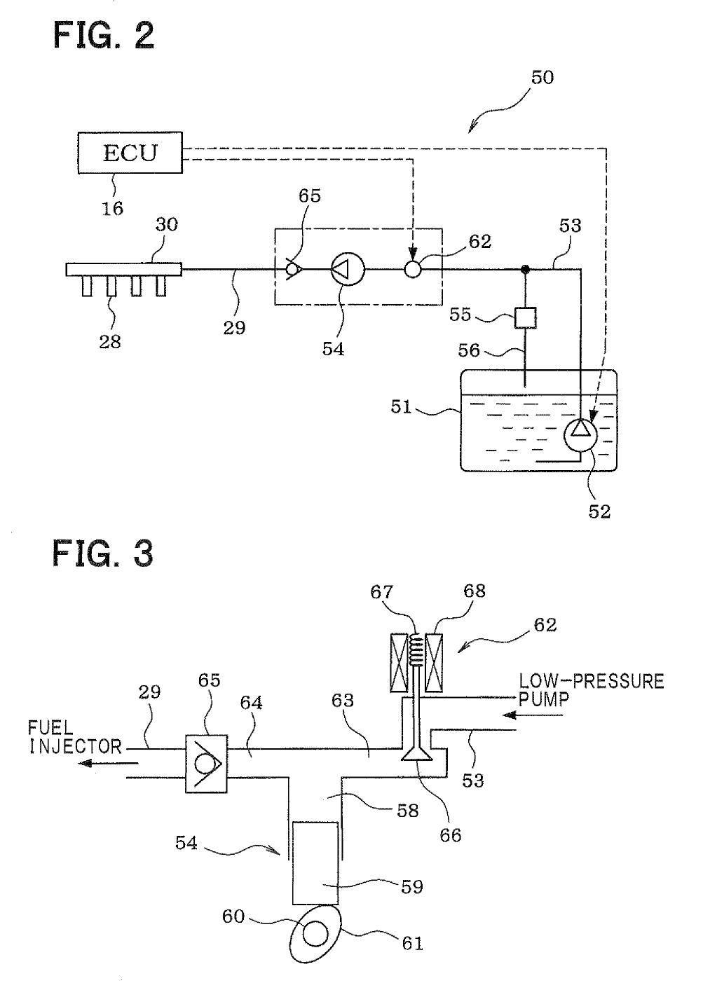

Referring to FIGS. 2 and 3, a configuration of a fuel supply apparatus 50 will be described. A low-pressure pump 52 pumping up the fuel is provided in a fuel tank 51. The low-pressure pump 52 is driven by an electric motor. The fuel discharged from the low-pressure pump 52 is supplied to a high-pressure pump 54 through a fuel pipe 53. The fuel pipe 53 is provided with a pressure regulator 55 which adjusts a discharge pressure of the low-pressure pump 52 to specified pressure (for example, 0.3 MPa). An excess fuel is returned to the fuel tank 51 through a fuel return pipe 56.

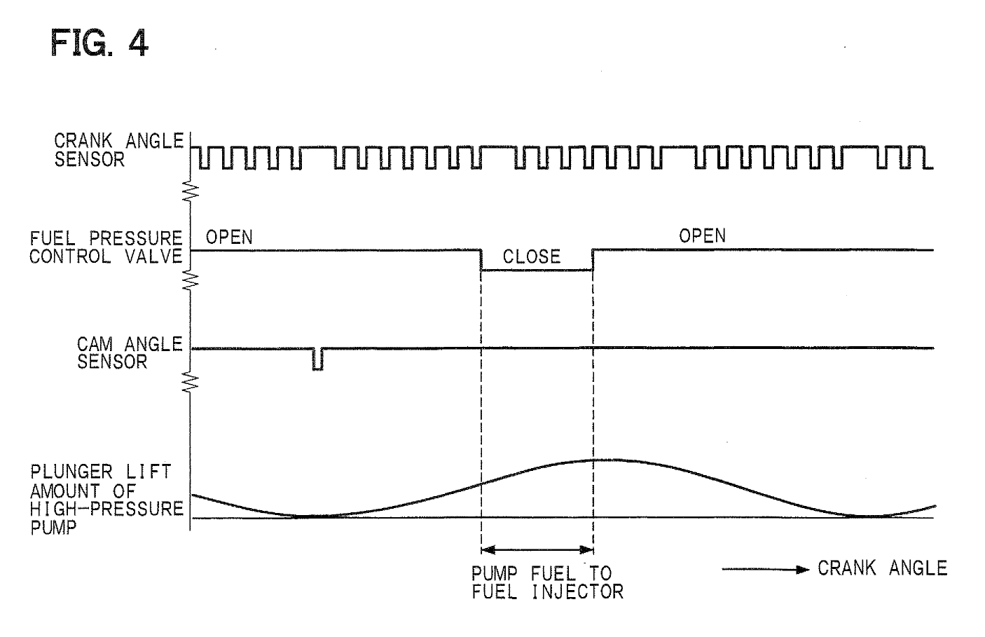

As shown in FIG. 3, the high-pressure pump 54 is a plunger pump which suctions/discharges the fuel by reciprocating a plunger 59 in a cylindrical pump chamber 58. The plunger 59 is driven by a cam 61 provided to a camshaft 60 of the engine 11. As shown in FIG. 4, a lift amount of the plunger 59 is periodically varied in accordance with the crank angle or cam angle.

As shown in FIG. 3, a fuel pressure control valve 62 is provided at a suction port 63 of pump chamber 58. The fuel pressure control valve 62 is a normally open electromagnetic valve. The fuel pressure control valve 62 includes a valve body 66 which opens/closes the suction port 63, a spring 66 which biases the valve body 66 in a open direction, and a solenoid 68 driving the valve body 66 in a close direction. When the solenoid 68 is not energized, the valve body 66 opens the suction port 63 by the biasing force of the spring 67. When the solenoid 68 is energized, the valve body 66 is attracted to close the suction port 63 against the biasing force of the spring 67.

In a suction stroke of the high-pressure pump 54, the fuel pressure control valve 62 is opened and the fuel is introduced into the pump chamber 58. In a discharge stroke of the high-pressure pump 54, a closing time of the fuel pressure control valve is controlled to adjust the fuel discharge amount and fuel pressure. For example, when the fuel pressure is increased, a closing start timing of the fuel pressure control valve 62 is expedited and a closing valve period is prolonged to increase fuel discharge amount. When the fuel pressure is decreased, the closing start timing of the fuel pressure control valve 62 is delayed and the closing valve period is shortened to decrease the fuel discharge amount.

A check valve 65 is provided at an outlet 64 of the pump chamber 58 to prevent a reverse flow of the discharged fuel. As shown in FIG. 2, the fuel discharged from the high-pressure pump 54 is supplied to a delivery pipe through a fuel pipe 29. The high-pressure fuel is delivered into the fuel injector 28 of each cylinder from the delivery pipe. The delivery pipe 30 is provided with a fuel pressure sensor 31 detecting the fuel pressure.

In order to reduce the power consumption of the fuel pressure control valve 62, the ECU 16 energizes the fuel pressure control valve 62 to close the fuel pressure control valve 62. The ECU 16 at a time when a specified time period has elapsed, determines that the valve closing force (fuel pressure) becomes larger than a valve opening force by a biasing force of the spring 67, and stops energization of the fuel pressure control valve 62. After that, the fuel pressure control valve 62 is closed by the fuel pressure until the discharge stroke is finished.

An energization start timing of the fuel pressure control valve 62 can be computed based on the engine speed and fuel discharge amount in accordance with an engine driving condition (demand fuel discharge amount). The energization start timing of the fuel pressure control valve 62 is established in the light of a fact that the fuel pressure control valve 62 is closed with a response delay time after the fuel pressure control valve 62 is energized.

The energization start timing control of the fuel pressure control valve 62 is based on a detection signal of the crank angle sensor 33 and a detection signal of the cam angle senor 32. When a detection accuracy of the crank angle sensor 33 or a cam angle sensor 32 is deteriorated, the energization start of the fuel pressure valve 62 can not be performed accurately. A controllability of the discharge amount of the high-pressure pump 54, especially, the controllability at maximum discharge amount is deteriorated.

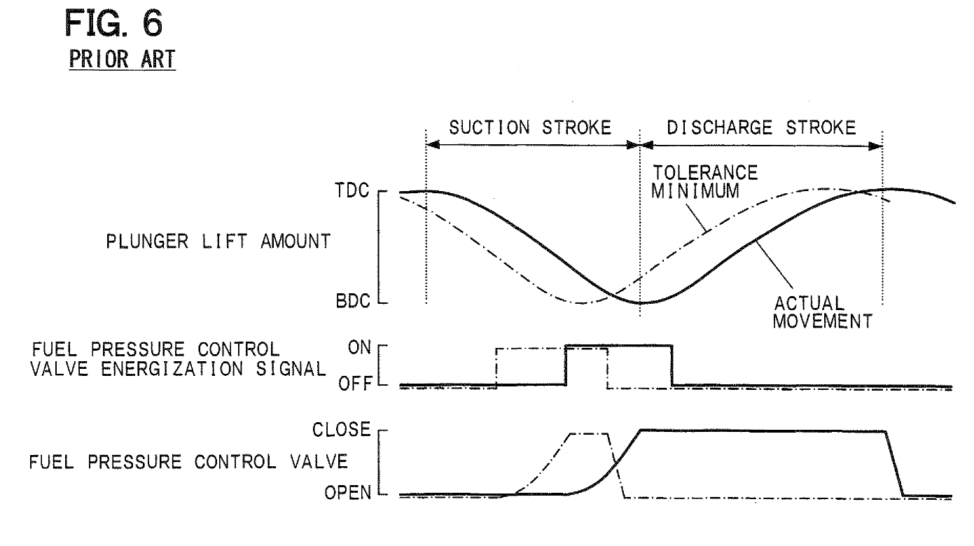

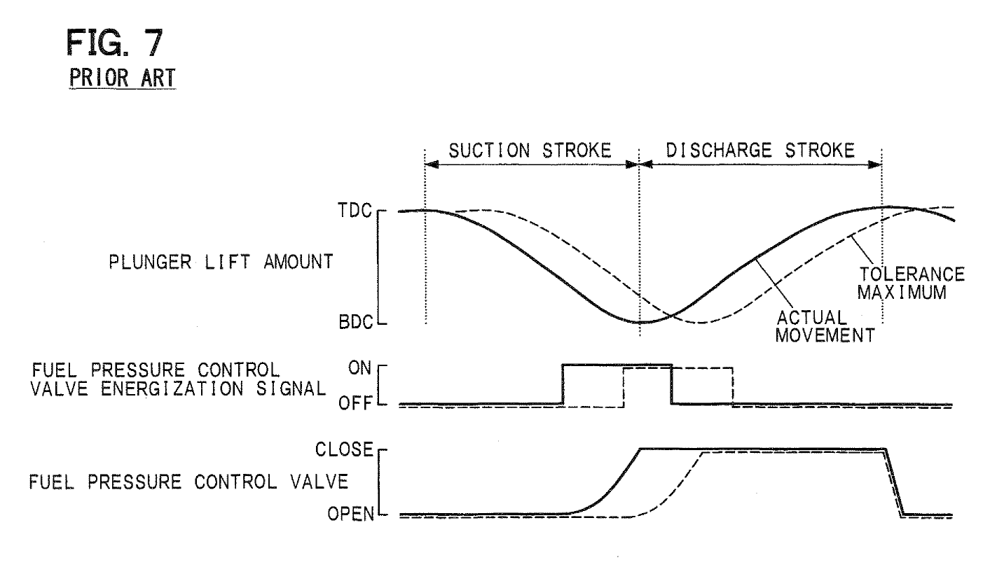

Referring to FIGS. 6 and 7, this problem will be described specifically. When the crank angle sensor 33 or the cam angle sensor 32 has tolerance dispersion, a detection accuracy disperses between tolerance minimum (dashed-dotted line) and tolerance maximum (dash line) with respect to an actual movement of the plunger 59 (solid line). FIGS. 6 and 7 are time charts showing that the fuel discharge amount (demand fuel discharge amount) of the high-pressure pump 54 is established maximum discharge amount. In FIGS. 6 and 7, when the crank angle senor 33 and the cam angle sensor 32 have no tolerance dispersion, ON/OFF of the fuel pressure control valve 62 and an opening/closing of the fuel pressure control valve 62 are performed as shown by a solid line. When the fuel discharge amount of the high-pressure pump 54 is the maximum discharge amount, the fuel pressure control valve 62 is closed until the plunger 59 reaches a top-dead-center from a bottom-dead center.

As described above, the energization start timing control to the fuel pressure control valve 62 is performed based on detection signals of the crank angle sensor 33 and the cam crank angle sensor 32. For example, when the detection error of the crank angle sensor 33 or the cam angle sensor 32 is tolerance minimum, as shown by a dashed-dotted line in FIG. 6, the energization start timing of the fuel pressure control valve 62 is established earlier, as compared with an ideal situation where the tolerance dispersion does not exist. In a case that the demand fuel discharge quantity is the maximum discharge amount, there is a possibility that the fuel pressure control valve 62 is deenergized before suction stroke has completed or the fuel pressure control valve 62 is deenergized before the fuel pressure rises to hold the condition that the fuel pressure control valve 62 is closed. As the result, the fuel pressure control valve 62 is opened, and there is a possibility that the high-pressure pump 54 can not discharge the fuel.

For example, when the detection error of the crank angle sensor 33 or the cam angle sensor 32 is tolerance maximum, the energization start timing to the fuel pressure control valve 62 is delayed, as compared with an ideal situation where the tolerance dispersion does not exist. Thus, in a case the demand fuel discharge quantity is the maximum discharge amount, the closing start timing of the fuel pressure control valve 62 is delayed than a bottom dead center of the plunger 59. The closing period of the fuel control valve 62 until the top dead center of the plunger 59 is shortened. As the result, the maximum discharge amount of the high-pressure pump 54 is restricted and the maximum discharge performance of the high-pressure pump 54 is not effectively used.

Since the detection error due to the tolerance dispersion of the crank angle sensor 33 and the cam angle sensor 32 varies according to the tolerance range, a learning processing can not deal.

According to the present embodiment, during a period in which the demand fuel discharge amount is greater than a specified amount (for example, around the maximum discharge amount), the energization period of the fuel pressure control valve 62 is prolonged so that a control performance of the high-pressure pump 54 around the maximum discharge amount is improved.

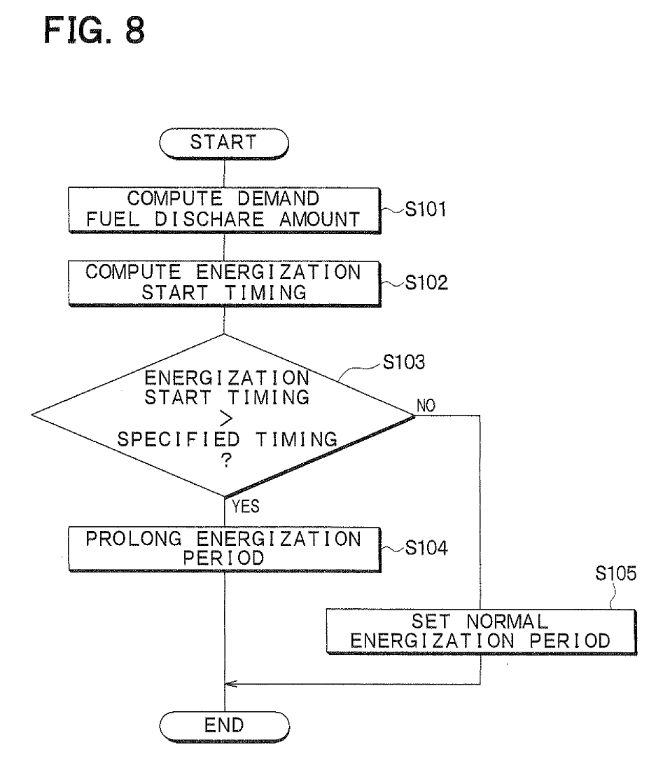

Referring to FIG. 8, a processing for prolonging the energization period of the fuel pressure control valve 62 will be described. This processing is repeatedly executed at a specified interval by the ECU 16 and corresponds to a pump control means and a prolong set means.

In step S101, a demand fuel discharge amount according to the engine driving condition is computed. This demand fuel discharge amount is computed based on an intake air quantity detected by an airflow meter and intake pressure sensor and air-fuel ratio of the exhaust gas detected by an air-fuel ratio sensor or oxygen sensor disposed in the exhaust pipe 37. The computing method of the demand fuel discharge amount can be arbitrarily changed. The demand fuel discharge amount can be computed only from the intake air quantity.

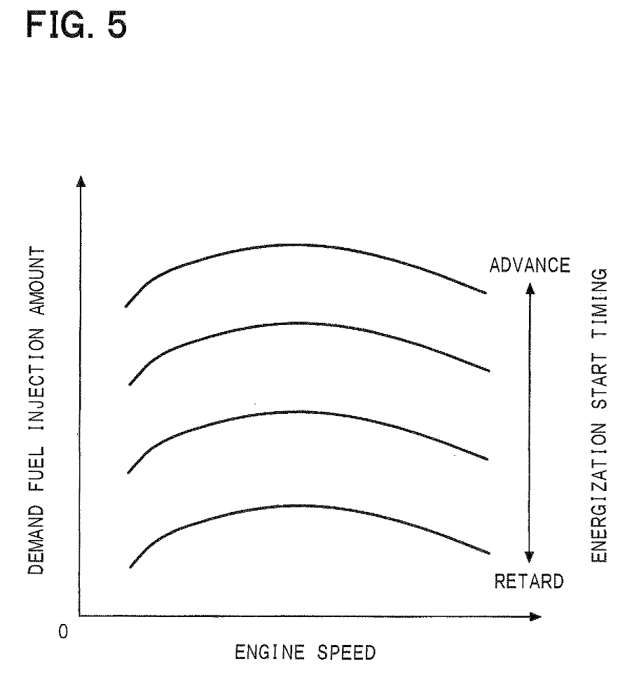

In step S102, an energization start timing of the fuel pressure control valve 62 is computed. This energizing start timing is computed based on the demand fuel discharge quantity computed in step S101 and the engine speed by use of the map shown in FIG. 5. Alternatively, the energization start timing can be computed based on a target fuel pressure and actual fuel pressure.

After computing the energization start timing, the procedure proceeds to step S103 in which it is determined that the energization start timing is greater than a specified timing. That is, in step S103, it is determined whether the energization start timing is earlier than the specified timing. The problems explained based on FIGS. 6 and 7 arise when the demand discharge amount of the high-pressure pump 54 is around the maximum discharge amount. Thus, the specified timing may be established based on the energization start timing at a time of maximum discharge amount in consideration of a tolerance range of the crank angle sensor 33 and the cam angle sensor 32. Besides, in step S103, it may be determined whether demand discharge amount of the high-pressure pump 54 is greater than a specified amount (for example, around maximum discharge amount).

When the energization start timing is smaller than the specified timing, that is, when the energization start timing is later than the specified timing, the procedure proceeds to step 105 in which a normal energization period is established. Besides, the normal energization period is established beforehand. The normal energization period is a period required to increase the fuel pressure in the pump chamber 58 to close the fuel pressure control valve 62.

When it is determined that the energization start timing is greater than the specified timing in step S103, that is, when the energization start timing is earlier than the specified timing, the procedure proceeds to step S104 in which the energization period is prolonged with respect to the normal energization period. In order to prolong the energization period, the energization start timing is expedited and the normal energization period is set longer by a specified time period. The specified time period is set long period based on the tolerance range (range from tolerance minimum to tolerance maximum) of the crank angle sensor 33 or a cam angle sensor 32. When the energization period is established in step S104 and S105, the fuel pressure control valve 62 is energized based on the energization period.

According to the present embodiment, when the demand fuel discharge quantity of the high-pressure pump 54 is around the maximum discharge quantity, the energization period of the fuel pressure control valve 62 is prolonged by the specified time period relative to the normal energization period. The energization start timing is expedited and the energization stop timing is delayed, so that the energization period of the fuel pressure control valve 62 is prolonged.

Even if the energization timing is expedited due to a tolerance dispersion in a system where the detection accuracy is deteriorated due to a tolerance dispersion of the crank angle sensor 33 and the cam angle sensor 32, the energization period of the fuel control valve 62 is elongated in an advance direction until the fuel pressure in the pump chamber 58 increases to hold the closed condition of the fuel pressure control valve 62. It is solved a conventional problem that the fuel pressure control valve 62 can not maintain a closing condition and the fuel can not be discharged.

Even in a case that the energization timing of the fuel pressure control valve 62 is delayed due to the tolerance dispersion, when the demand fuel discharge amount is around the maximum discharge amount, the energization timing of the fuel pressure control valve 62 is prolonged in a retard direction (the energization start timing is expedited). The maximum discharge performance of the high-pressure pump 54 is effectively utilized.

According to the present invention, since the conventional problems can be solved by prolonging the energization period of the fuel pressure control valve 62, a system configuration is not changed and a part of a soft ware is changed to apply the present invention, so that a demand of low cost is satisfied. Furthermore, when the demand fuel discharge amount is less than a specified amount, the energization period of the fuel pressure control valve 62 is not prolonged. An increase in a power consumption is restricted.

According to the present invention, the prolonged period of the energization period is established based on the tolerance range of a crank angle sensor 33 and the cam angle sensor 32, but the present invention is not limited thereto. The energization period corresponding to the discharge stroke is established in such a manner that the fuel pressure control valve 62 is closed during a discharge stroke.

When the demand fuel discharge amount of the high-pressure pump 54 is around the maximum discharge amount, the energization period of the fuel pressure control valve 62 is prolonged. Alternatively when an accelerator senor detects that a driver fully steps the accelerator pedal, it is determined that the demand fuel discharge amount is around the maximum discharge amount and the energization period of the fuel pressure control valve 62 can be prolonged.

In a case that the energization start timing of the fuel pressure control valve 62 is controlled by use of the cam angle sensor, a MRE sensor including a magnetoresistance element which linearly detects the cam angle can be used.

What is claimed is:

1. A controller for an internal combustion engine comprising:
a high-pressure pump including
a pump chamber having a suction port and a discharge port of a fuel,
a plunger reciprocating in the pump chamber to suction/discharge the fuel,
a valve body opening/closing the suction port, and
a fuel pressure control valve closing the valve body by an electromagnetic force, the fuel pressure control valve having a biasing means biasing the valve body in a closing direction;
a pump control means for controlling an energization period of the fuel pressure control valve according to a demand fuel discharge amount for every discharge stroke so that a fuel discharge amount is controlled to the demand fuel discharge amount, wherein
the energization period of the fuel pressure control valve is established as a specified period in which the fuel pressure in the pump chamber holds the valve body at a closed position against the biasing force of the biasing means, and after the energization is finished, the valve body is hold at the closed position by the fuel pressure until the discharge stroke is finished, the controller further comprising
a prolong set means for prolonging the energization period of the fuel pressure control valve by a specified period during a period in which the demand fuel discharge amount is greater than a specified amount.

2. A controller for an internal combustion engine according to claim 1, wherein the prolong set means prolongs the energization period of the fuel pressure control valve by the specified period during a period in which the demand fuel discharge is around a maximum discharge amount.

3. A controller for an internal combustion engine according to claim 1, wherein the prolong set means expedites an energization start timing of the fuel pressure control valve and delays an energization stop timing of the fuel pressure control valve, so that the energization period of the fuel control valve is prolonged in an advance direction and a retard direction by the specified period.

4. A controller for an internal combustion engine according to claim 1, the prolong set means prolongs the energization period of the fuel pressure control valve in such a manner that the fuel pressure control valve is maintained at closed position until the plunger reaches a top dead center from a bottom dead center during a period in which the demand fuel discharge amount is around the maximum discharge amount.
